(19) United States
(12) Patent Application Publication
(10) Pub. No.: US 2013/0325575 A1
(43) Pub. Date: Dec. 5, 2013

(54) METHOD AND SYSTEM FOR PROCESSING VARIABLE REDEMPTION VALUE ELECTRONIC COUPONS

(71) Applicant: Nathanlel BYRD, Saint Peters, MO (US)

(72) Inventor: Nathanlel BYRD, Saint Peters, MO (US)

(73) Assignee: MasterCard International Incorporated, Purchase, NY (US)

(21) Appl. No.: 13/486,274

(22) Filed: Jun. 1, 2012

(51) Int. Cl. G06Q 30/02

(52) U.S. Cl. 705/14.23; 705/14.26

(57) ABSTRACT

Methods and apparatuses for carrying out processing a financial transaction includes: receiving, by a receiving device, an authorization request for a financial transaction wherein the authorization request includes at least a transaction amount and a coupon identifier; identifying, in a database, coupon information based on the coupon identifier, wherein the coupon information includes at least a discount amount; modifying the transaction amount based on the discount amount; processing, by the processing device, the authorization request for the financial transaction based on the modified transaction amount; and transmitting, by a transmitting device, a response to the authorization request, wherein the response includes at least the modified transaction amount and discount amount. The coupons can be coupled to geographic location and or an immediate purchasing period.

### FIELD

The present disclosure relates to methods and systems for processing variable redemption value electronic coupons, specifically variable redemption value electronic coupons whose value is unknown to the coupon holder until either at the merchant location or upon committing to spend in a financial transaction.

### BACKGROUND

For well over a century coupons have been used to attract consumers to merchants and influence spending. Merchants often use coupons to entice consumers to visit a physical location, and sometimes will provide additional coupons to a consumer after a transaction in order to encourage repeat business. Some merchants have begun to provide coupons following transactions that have values unknown to the consumer, such as through scratch-off cards with the value obscured until a sales associate reveals the value or a gift card whose value is unknown until the consumer takes the card into a merchant location to be scanned.

However, in instances such as these, there is the potential that the value of the coupon or card can be discovered by the consumer prior to returning to the merchant. Further, in many instances the value of the coupon may need to be assigned to the coupon prior to its use or return to the store, such as the case with scratch-off coupons. This can limit promotional possibilities and also can adversely affect marketing and analytic information gathering and analysis as coupons may be blindly distributed to consumers with little if any regard for consumer information, and consumers may be free to trade or exchange coupons. Thus, there is a perceived opportunity to improve the technology of variable redemption value coupons such that their values may not be predetermined and may be dependent on the consumer with the coupon, which can result in higher consumer satisfaction and more beneficial marketing and reporting information.

### SUMMARY

The present disclosure provides a description of systems and methods for processing variable redemption value electronic coupons.

A method for processing a financial transaction includes: receiving, by a receiving device, an authorization request for a financial transaction wherein the authorization request includes at least a transaction amount and a coupon identifier; identifying, in a database, coupon information based on the coupon identifier, wherein the coupon information includes at least a discount amount; modifying the transaction amount based on the discount amount; processing, by the processing device, the authorization request for the financial transaction based on the modified transaction amount; and transmitting, by a transmitting device, a response to the authorization request, wherein the response includes at least the modified transaction amount and discount amount.

Another method for processing a financial transaction includes: reading, from a payer device, a machine-readable code, wherein the machine-readable code is encoded with a coupon identifier; transmitting, by a transmitting device, an authorization request for a financial transaction, wherein the authorization request includes at least a transaction amount and the coupon identifier; receiving, by a receiving device, a response to the authorization request, the response including at least a modified transaction amount and a discount amount; and processing the financial transaction based on the modified transaction amount.

A method for distributing a value of an electronic coupon includes: storing, in a database, a plurality of coupon value rules, wherein each coupon value rule in the plurality of coupon value rules is associated with at least a coupon identifier and a location identifier; receiving, by a receiving device, a request for a value of an electronic coupon, wherein the request includes at least a coupon identification value and a location identification value; identifying, in the database, at least one coupon value rule in the plurality of coupon value rules where the associated coupon identifier corresponds to the coupon identification value and the associated location identifier corresponds to the location identification value; determining, by a processing device, the value of the electronic coupon based on the identified at least one coupon value rule; and transmitting, by a transmitting device, a response to the request for the value of the electronic coupon wherein the response includes at least the determined value of the electronic coupon.

A method for obtaining the value of an electronic coupon includes: storing, in a database of a mobile communication device, a coupon identifier associated with the electronic coupon; identifying a geographic location of the mobile communication device; transmitting, by a transmitter of the mobile communication device, a request for the value of the electronic coupon, wherein the request includes at least the stored coupon identifier and the identified geographic location; receiving, by a receiver of the mobile communication device, a response to the request for the value of the electronic coupon wherein the response includes at least the value of the electronic coupon; and displaying, by a display of the mobile communication device, the value of the electronic coupon.

A system for processing a financial transaction includes: a receiving device, a database, a processor, and a transmitting device. The receiving device is configured to receive an authorization request for a financial transaction wherein the authorization request includes at least a transaction amount and a coupon identifier. The database is configured to store coupon information for a coupon associated with the coupon identifier, wherein the coupon information includes at least a discount amount. The processor is configured to identify the coupon information for the coupon associated with the coupon identifier, modify the transaction amount based on the discount amount, and process the authorization request for the financial transaction based on the modified transaction amount. The transmitting device is configured to transmit a response to the authorization request, wherein the response includes at least the modified transaction amount and discount amount.

Another system for processing a financial transaction includes: a reader device configured to read, from a payer device, a machine-readable code, wherein the machine-readable code is encoded with a coupon identifier; a transmitting device configured to transmit an authorization request for a financial transaction, wherein the authorization request includes at least a transaction amount and the coupon identifier; a receiving device configured to receive a response to the authorization request, the response including at least a modified transaction amount and a discount amount; and a processor configured to process the financial transaction based on the modified transaction amount.

A system for distributing a value of an electronic coupon includes a database, a receiving device, a processor, and a transmitting device. The database is configured to store a plurality of coupon value rules, wherein each coupon value rule in the plurality of coupon value rules is associated with at least a coupon identifier and a location identifier. The receiving device is configured to receive a request for a value of an electronic coupon, wherein the request includes at least a coupon identification value and a location identification value. The processor is configured to identify, in the database, at least one coupon value rule in the plurality of coupon value rules where the associated coupon identifier corresponds to the coupon identification value and the associated location identifier corresponds to the location identification value, and determine the value of the electronic coupon based on the identified at least one coupon value rule. The transmitting device is configured to transmit a response to the request for the value of the electronic coupon wherein the response includes at least the determined value of the electronic coupon.

A mobile communication device includes a database configured to store a coupon identifier associated with the electronic coupon; identifying a geographic location of the mobile communication device; a transmitter configured to transmit a request for the value of the electronic coupon, wherein the request includes at least the stored coupon identifier and the identified geographic location; a receiver configured to receive a response to the request for the value of the electronic coupon wherein the response includes at least the value of the electronic coupon; and a display configured to display the value of the electronic coupon.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a financial transaction processing system for processing variable redemption value electronic coupons in accordance with exemplary embodiments.

FIG. 2 is a block diagram illustrating a system for processing financial transactions including electronic coupons and obtaining and distributing values of variable redemption coupons in accordance with exemplary embodiments.

FIG. 3 is a block diagram illustrating a financial transaction processing server for use in the system of FIG. 2 in accordance with exemplary embodiments.

FIG. 4 is a block diagram illustrating a mobile communication device for use in the system of FIG. 2 in accordance with exemplary embodiments.

FIG. 5 is a block diagram illustrating a coupon value rule database in accordance with exemplary embodiments.

FIG. 6 is a diagram illustrating a graphical user interface of a mobile communication device in accordance with exemplary embodiments.

FIG. 7 is a block diagram illustrating an exemplary computer architecture in accordance with exemplary embodiments.

FIGS. 8 and 9 are flow charts illustrating methods for processing a financial transaction in accordance with exemplary embodiments.

FIG. 10 is a flow chart illustrating a method for distributing the value of an electronic variable redemption value coupon using a geographic location in accordance with exemplary embodiments.

FIG. 11 is a flow chart illustrating a method for obtaining the value of an electronic variable redemption value coupon using a geographic location in accordance with exemplary embodiments.

FIG. 12 is a flow chart illustrating a method for distributing the value of an electronic variable redemption value coupon with an immediate purchasing period for redemption in accordance with exemplary embodiments.

FIG. 13 is a flow chart illustrating a method for obtaining the value of an electronic variable redemption value coupon with an immediate purchasing period for redemption in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Financial Transaction—An event that involves the exchange of money or payment between two parties. For example, a consumer purchasing goods or services from a merchant, a borrower borrowing money from a lender, a consumer giving a bank money for deposit in a bank account, etc. As described herein, a payment card transaction may include a financial transaction where a payment card is used for payment.

Coupon—A voucher that may entitle the holder to a discount or other incentive for purchasing a product or service. A product may be any type of good or service as will be apparent to persons having skill in the relevant art. As used herein, “discount” may be any type of discount suitable for performing the functions as disclosed herein, such as a percentage off, a flat number discount, free distribution of a product, etc.

Issuer—An entity that issues a payment card to a consumer. Types of entities that may be an issuer may include a financial institution, such as a bank or credit union, a financial transaction processing agency, a merchant, or any other organization or institution that may issue a payment card to a consumer.

Acquirer—An entity that acts as an intermediary between merchants and consumers. For example, an acquirer may process financial transactions on behalf of the merchant, such as by communicating with the consumer's issuer to secure funds for a payment card transaction. Types of entities that may be an acquirer include entities discussed above that may act as an issuer, such as a bank or other entities.

Financial Transaction Processing Agency—An entity that processes financial transaction (e.g., payment card transactions), such as MasterCard, VISA, American Express, etc. In many instances, a financial transaction processing agency may act on behalf of, or may operate as, an acquirer and/or an issuer. For example, a financial transaction processing agency may issue a payment card to a consumer, and then process a transaction using that payment card by paying the transaction amount to a merchant and billing the consumer for the amount.

### Financial Transaction Processing System

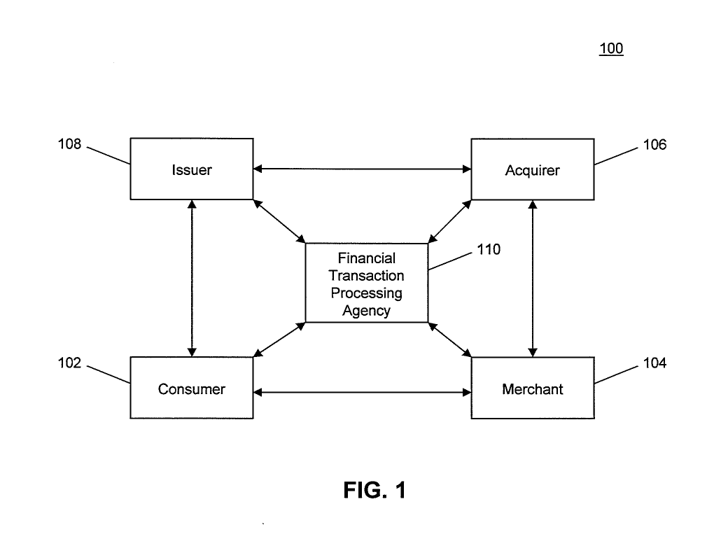

FIG. 1 illustrates a system 100 for processing a financial payment card transaction. The system 100 may include a consumer 102 that may initiate or otherwise engage in a financial transaction with a merchant 104. The consumer 102 may have an electronic coupon that the consumer 102 may provide to the merchant 104 as part of the financial transaction. The merchant 104 may provide details of the financial transaction (e.g., including electronic coupon details) to an acquirer 106. Transaction details may include costumer information, merchant information, transaction amount, date and time information, product or service details, etc.

The acquirer 106 may request authorization of the financial transaction from a financial transaction processing agency 110. In one embodiment, the acquirer 106 and the financial transaction processing agency 110 may be a single entity and the merchant 104 may request the authorization. The financial transaction processing agency 110 may identify coupon value rules for a variable redemption value coupon, as discussed in more detail below. After application of the coupon value rules, the financial transaction processing agency 110 may process the transaction, such as by contacting the issuer 108 for approval or denial of the transaction and reporting the same to the acquirer 106 or the merchant 104.

Once the transaction has been approved or denied, the merchant 104 can finalize the transaction with the customer 102. For example, if the transaction has been approved, the merchant 104 can provide the transacted-for goods or services to the customer 102 and receive payment (e.g., from the issuer 108), and the customer 102 can be billed for the transaction by the issuer 108.

### Variable Redemption Value Electronic Coupon System

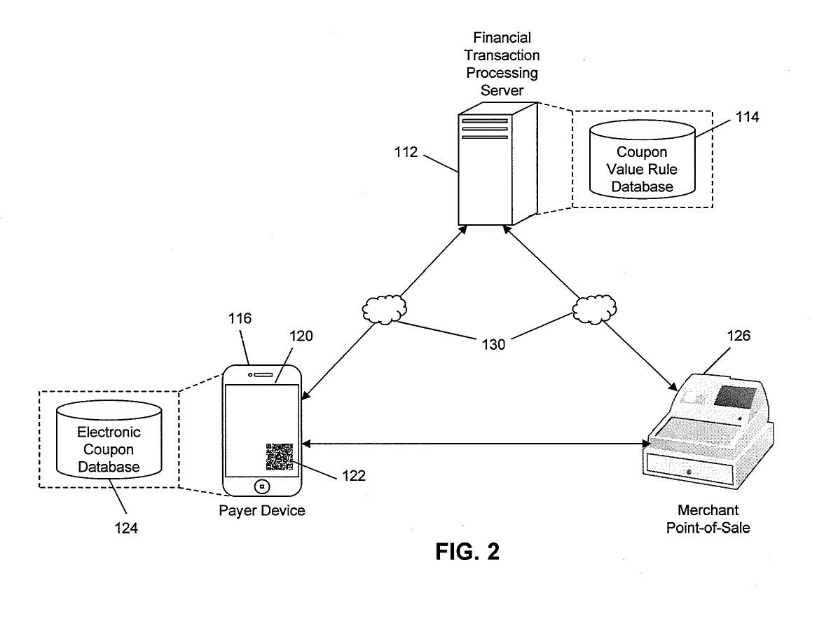

FIG. 2 illustrates a system for the processing of financial electronics including, the obtaining of, and the distribution of variable redemption value electronic coupons.

The consumer 102 may use a payer device 116. The payer device 116 may be a mobile communication device, as discussed in more detail below. In one embodiment, the mobile communication device may be a cellular phone. In a further embodiment, the mobile communication device may be a smart phone. Other devices suitable for performing the functions of the payer device 116 as discussed herein will be apparent to persons having skill in the relevant art and may include laptop computers, tablet computers, and slates.

An electronic coupon may be displayed on a display 120 of the payer device 116. In some embodiments, the coupon may include a machine-readable code 122, which may be encoded with at least a coupon identifier (e.g., a unique value associated with the coupon), discussed in more detail below. In an exemplary embodiment, the machine-readable code may not be encoded with the value of the coupon. For example, the value of the coupon may be variable and undetermined until the payer device 116 is at a particular location (e.g., of the merchant 104) or the electronic coupon is used for redemption. In some embodiments, additionally or alternatively the coupon may be associated with an immediate purchasing period, defined in more detail below, during which time the coupon need be redeemed.

The payer device 116 may include an electronic coupon database 124, discussed in more detail below, which may store a plurality of coupon identifiers corresponding to electronic coupons. In one embodiment, the electronic coupon database 124 may not include any information on the value of the corresponding coupons. In another embodiment, the electronic coupon database 124 may only include information on the value of a coupon subsequent to obtaining the value based on coupon value rules, discussed further below.

In one embodiment, the payer device 116 may obtain the value of an electronic coupon from the financial transaction processing server 112. In another embodiment, the consumer 102 may communicate a coupon to the merchant 104, who may then process a financial transaction including the coupon, whose value may be determined by the financial transaction processing server 112 while processing the transaction. The consumer 102 may communicate the coupon to the merchant 104 by providing the coupon identifier associated with the coupon. Methods for providing the coupon identifier to the merchant 104 will be apparent to persons having skill in the relevant art and may include the merchant 104 manually inputting the coupon identifier in a merchant point-of-sale (POS) 126, the merchant 104 scanning the machine-readable code 122 from the payer device 116 (e.g., using a reader device connected to the merchant POS 126), etc.

The financial transaction processing server 112 may determine the value of a coupon (e.g., in response to a request for the value from the payer device 116 or while processing an authorization request from the merchant 104) by using at least one coupon value rule which may be stored in a coupon value rule database 114. The coupon value rule database 114 may store a plurality of coupon value rules, discussed in more detail below, which may be used to determine the value of a variable redemption value coupon. The financial transaction processing server 112 may transmit the value of the coupon to the consumer via the payer device 116, or to the merchant 104 with a response to an authorization request.

Communication between the financial transaction processing server 112 and the payer device 116 and the merchant POS 126 may be via a network 130. The network 130 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Further, the network 122 may be coupled to, piggy-backed on or actually, in whole or in part, a financial transaction network, such as MasterCard's BankNet with the potential advantages of the pre-established security, connectivity, and acceptance. Other suitable network types and configurations will be apparent to persons having skill in the relevant art.

### Financial Transaction Processing Server

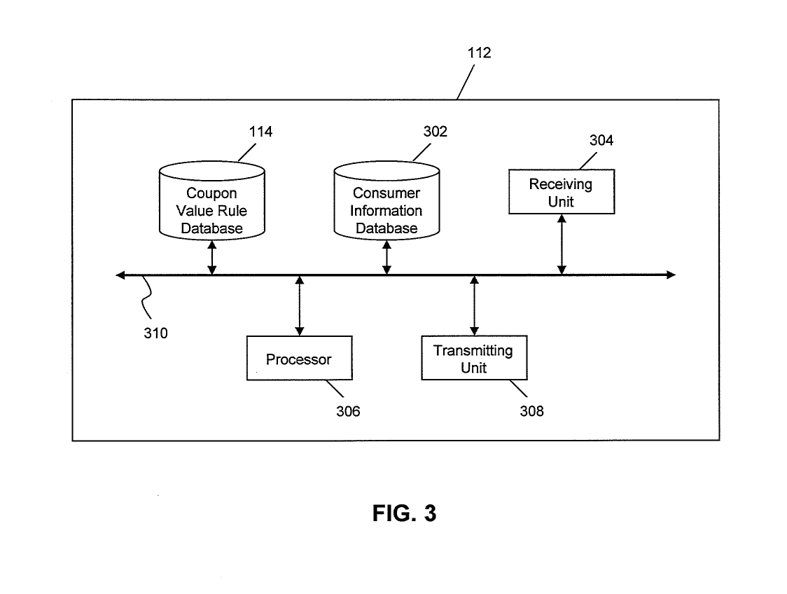

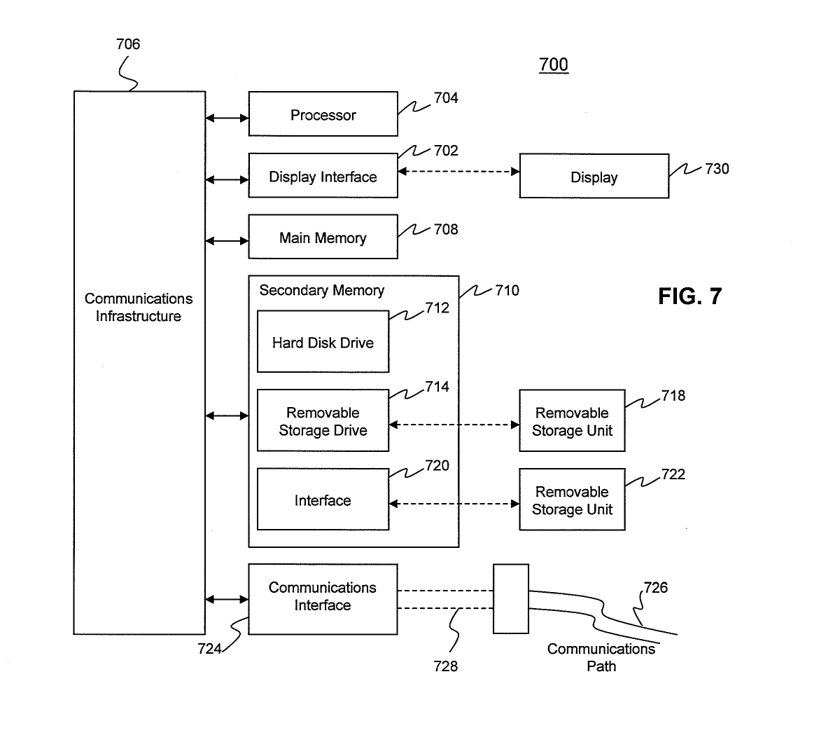

FIG. 3 is an illustration of the financial transaction processing server 112, which can be part of or a separate entity from the financial transaction processing agency 110 (FIG. 1). The financial transaction processing server 112 may include the coupon rule value database 114, a consumer information database 302, a receiving unit 304, a processor 306, and a transmitting unit 308. Each of the components may be connected via a bus 310. Suitable types and configurations of the bus 310 will be apparent to persons having skill in the relevant art. Other suitable configurations of the financial transaction processing server 112 will be apparent to persons having skill in the relevant art. In one embodiment, the financial transaction processing server 112 may be a computer system such as the computer system 700 illustrated in FIG. 7, described in more detail below.

The coupon value rule database 114 may include a plurality of coupon value rules, discussed in more detail below. Each of the coupon value rules in the coupon value rule database 114 may include information identifying rules for determining the value of a variable redemption value coupon. The consumer information database 302 may include information associated with a plurality of consumers (e.g., the consumer 102). The information included in the consumer information database 302 may include demographic information (e.g., age, gender, marital status, income, residential status, etc.), transaction information (e.g., purchase history, credit history, etc.), or other information suitable for performing the functions as disclosed herein as will be apparent to persons having skill in the relevant art. In an exemplary embodiment, information in the consumer information database 302 may be provided by the consumer (e.g., the consumer 102) and/or obtained only with consent of the consumer 102. In one embodiment, information included in the consumer information database 302 may be bucketed or aggregated to protect consumer privacy (e.g., age or income of the consumer may be grouped, such as an age of 36 becoming an age of 30-40).

The coupon value rule database 114 and the consumer information database 302 (e.g., and the electronic coupon database 124, discussed below) may include data stored on any type of suitable computer readable media, such as optical storage (e.g., a compact disc, digital versatile disc, blu-ray disc, etc.) or magnetic tape storage (e.g., a hard disk drive). The coupon value rule database 114 and the consumer information database 302 may be configured in any type of suitable database configuration, such as a relational database, a structured query language (SQL) database, a distributed database, an object database, etc. Suitable configurations and database storage types will be apparent to persons having skill in the relevant art. Each of the coupon value rule database 114 and the consumer information database 302 may be a single database, or may comprise multiple databases which may be interfaced together (e.g., physically or via a network, such as the network 130). In one embodiment, the coupon value rule database 114 and the consumer information database 302 may be a single database.

In one embodiment the receiving unit 304 may be configured to receive a request for the value of an electronic coupon. The request for the value of an electronic coupon may include at least a coupon identifier (e.g., a value unique to the electronic coupon) and a location identifier (e.g., a value unique to a physical and/or geographic location) as will be discussed in more detail below. In some embodiments, the request for the value of an electronic coupon may include only a coupon identifier, where the electronic coupon may have an associated immediate purchasing period for redemption, as discussed in more detail below.

In another embodiment, the receiving unit 304 may be configured to receive an authorization request for a financial transaction including a variable redemption value coupon. The authorization request may include, in addition to traditional transaction information as will be apparent to persons having skill in the relevant art, a coupon identifier associated with an electronic coupon. In one embodiment, the coupon identifier may be stored in a custom field of the authorization request. In a further embodiment, the authorization request may be formatted pursuant to the International Organization for Standardization ISO 8583 standard.

The processor 306 may be configured to identify at least one coupon value rule in the coupon value rule database 114 corresponding to the coupon identifier (e.g., and location identifier) received by the receiving unit 304. The processor 306 may be further configured, in some embodiments, to determine the value of the electronic coupon associated with the coupon identifier based on rules in the identified at least one coupon value rule. The processor 306 may also be configured to process financial transactions. Methods of processing of financial transactions will be apparent to persons having skill in the relevant art. In an exemplary embodiment, the processor 306 may be configured to modify a financial transaction based on the determined (e.g., or identified) value of an electronic coupon used in the financial transaction. The processor 306 may be a single processor or may comprise multiple processors interfaced together, and may include multiple processor cores.

The transmitting unit 308 may be configured to transmit a response to an authorization request (e.g., indicating if a financial transaction is approved or denied) and/or a determined or identified value of an electronic coupon in response to a request for the value of the electronic coupon. In one embodiment, responses to an authorization request are formatted pursuant to the ISO 8583 standard. In one embodiment, the transmitting unit 308 may be configured to transmit an immediate purchasing period associated with an electronic coupon, discussed in more detail below.

### Mobile Communication Device

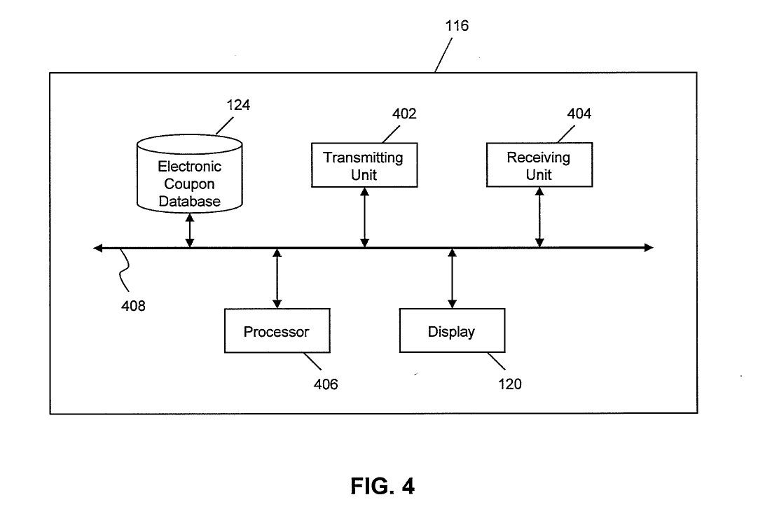

FIG. 4 is an illustration of the mobile communication device (e.g., the payer device) 116. The mobile communication device 116 may include the electronic coupon database 124, a transmitting unit 402, a receiving unit 404, a processor 406, and the display 120. Each of the components may be connected via a bus 408. Suitable types and configurations of the bus 408 will be apparent to persons having skill in the relevant art. Other suitable configurations of the mobile communication device 116 will be apparent to persons having skill in the relevant art. In one embodiment, the mobile communication device 116 include a computer system such as the computer system 700 illustrated in FIG. 7, described in more detail below.

The electronic coupon database 124 may include at least one electronic coupon, which may be a variable redemption value electronic coupon. Each electronic coupon may include at least a coupon identifier associated with the electronic coupon. In some embodiments, an electronic coupon stored in the electronic coupon database 124 may also be associated with an immediate purchasing period for redemption, discussed in more detail below. The transmitting unit 402 may be configured to transmit a request for the value of a variable redemption value coupon (e.g., stored in the electronic coupon database 124). The request for the value of the coupon may include at least the coupon identifier associated with the coupon.

The receiving unit 404 may be configured to receive a response to a request for the value of a variable redemption value coupon. In an exemplary embodiment, the response may include at least the value of the coupon. In one embodiment, the receiving unit 404 may be configured to receive a machine-readable code (e.g., the machine-readable code 122) encoded with the value of the electronic coupon and/or the coupon identifier.

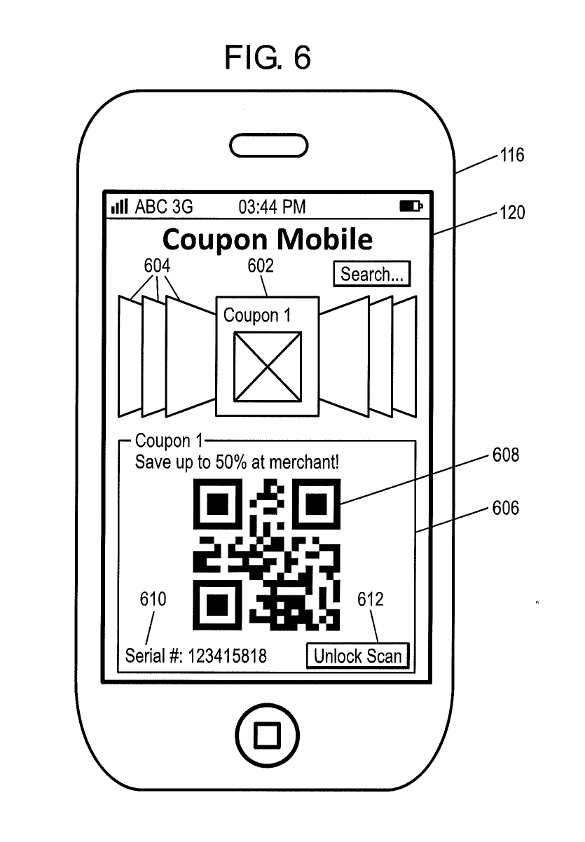

The processor 406 may be configured to cause the display 120 to display the received value of the coupon. The display 120 may be configured to display electronic coupons and their associated values. In an exemplary embodiment, the display 120 may be configured to display machine-readable code (e.g., the machine-readable code 122), which may be encoded with at least the coupon identifier and/or value associated with an electronic coupon. In one embodiment, the processor 406 may be configured to generate (e.g., create, process, etc.) the machine-readable code 122 encoded with a coupon identifier and a received value of the associated electronic coupon. In one embodiment, the machine-readable code 122 may be a bar code. In a further embodiment, the bar code may be a QR code. The display 120 may be further configured to simultaneously display a plurality of electronic coupons, such as illustrated in FIG. 6, described below.

### Coupon Value Rules

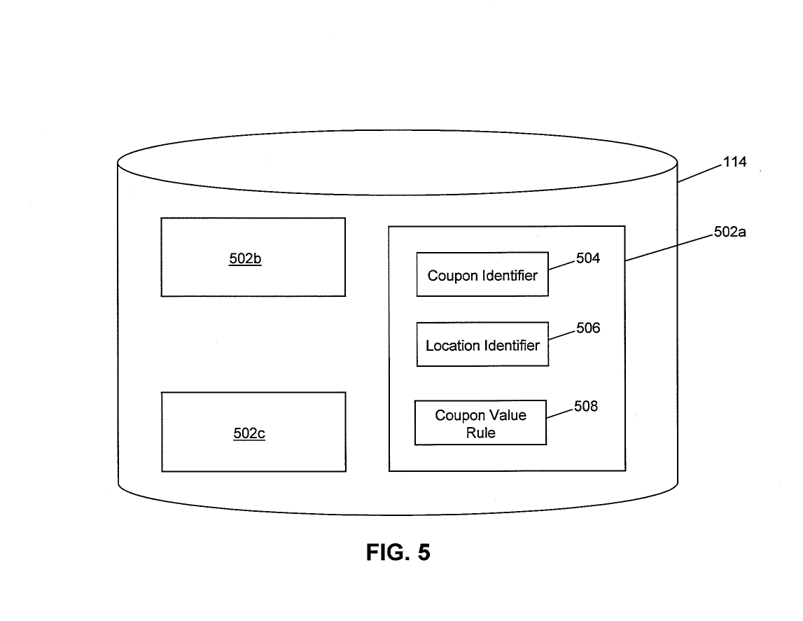

FIG. 5 is an illustration of the coupon value rule database 114. The coupon value rule database 114 may include a plurality of coupon value rules, such as the coupon value rules 502a, 502b, and 502c. Each coupon value rule 502 in the plurality of coupon value rules may include at least a coupon identifier 504, a location identifier 506, and at least one value rule 508.

The coupon identifier 504 may be a unique value associated with the coupon value rule 502. In one embodiment, the coupon identifier 504 may be a number, such as a universal product code (UPC). In some embodiments, the coupon identifier 504 may be assigned by the financial transaction processing agency 110. In other embodiments, the coupon identifier 504 may be assigned by the merchant 104, a manufacturer (e.g., of the product associated with the corresponding coupon), or a third party.

The location identifier 506 may be a unique value associated with a physical or geographical location. For example, the location identifier 506 may be associated with a specific physical location of the merchant 104 (e.g., a particular store, branch, etc.). In some embodiments the location identifier 506 may be unique value associated with multiple locations (e.g., all physical locations of the merchant 104, participating merchants in a specific area, etc.). The location identifier 506 may include a geographical value (e.g., coordinates) and may further include a distance (e.g., a radius) near the geographical value that may satisfy location requirements. The location identifier 506 may also include a value associated with a location, such as a store number for a store of the merchant 104. Other types of identifiers and/or values suitable for the location identifier 506 will be apparent to persons having skill in the relevant art.

The location identifier 506 may be used such that the value of a variable redemption value coupon may not be determined and/or distributed unless the consumer 102 (e.g., the payer device 116) is within a predetermined area. For example, the value of a variable redemption value coupon may not be determined and/or may be withheld from the consumer 102 until the consumer is within a predetermined distance of the merchant 104, or is inside of a physical location of the merchant 104. Suitable methods for identifying the location of the consumer 102 (e.g., the payer device 116) will be apparent to persons having skill in the relevant art and may include scanning a machine-readable code (e.g., a bar code, a QR code, etc.) at the merchant 104 with the payer device 116, connecting the payer device 116 to a localized network (e.g., WiFi), receiving (e.g., by the payer device 116) an aural signal transmitted by a device at the merchant 104, reporting by a mobile communication network (e.g., cellular network), etc.

In alternative embodiments (either as an additional feature or an alternative feature), the location identifier 506 may not be used, and the corresponding electronic coupon may be associated with an immediate purchasing period for redemption. Such an embodiment may be used, for example, for Internet or other remote commercial transactions, where the consumer 102 may be at a variety of locations. The immediate purchasing period may be a period of time reasonable for the consumer 102 to initiate and conduct a transaction with the merchant 104. It will be apparent to persons having skill in the relevant art that the immediate purchasing period may depend on a number of factors, such as the size of the merchant 104, the type of financial transaction, the type of product for which the electronic coupon is to be applied, the location of the transaction, etc. For example, en electronic coupon to be used at a large retail store may be associated with a 30 minute immediate purchasing period, whereas an electronic coupon to be used at an online retailer may be associated with a 5 minute immediate purchasing period. In some embodiments, the location identifier 506 may be used in combination with the immediate purchasing period.

The value rule 508 may include a rule (e.g., parameter) for determining the value of the corresponding coupon. In an exemplary embodiment, the value of the corresponding coupon may not be determined until the value is requested (e.g., by the payer device 116 at the specified location, the merchant 104, etc.). The value rule 508 may be a single value rule 508 or may consist of multiple value rules in combination, as discussed herein. In one embodiment, the value rule 508 may be determined by the merchant 104. Each value rule 508 may include parameters for determining the value of the corresponding coupon and may or may not be based on additional criteria.

For example, one value rule 508 may be that the corresponding coupon is assigned a random percentage off within a predetermined range, such as a coupon for anywhere between 10% and 50% off. In some instances, a coupon may be randomly assigned a percentage off from a list of percentages, such as 10%, 20%, 30%, 40%, or 50% off. A value rule 508 may also include parameters for the likelihood of specific number or percentage off, such as a rule where the consumer 102 has a 64% chance to get a 10% off coupon, a 30% chance for 15% off, a 5% chance for 25% off, and a 1% chance for 50% off.

A value rule 508 may also specify a maximum number of coupons for a specific value in a list of values. For example, a value rule 508 may include that only a specified number (e.g., 200) of a value (e.g., 50% off) may be assigned to a coupon. In some instances, the specified number may be assigned randomly (e.g., to 200 random consumers). In other instances, the number may be assigned to consumers on a first-come, first-served basis (e.g., the first 200 consumers to enter a location of the merchant 104 get a 50% off value assigned to their coupon, the next 400 consumers get 25% off, etc.).

A value rule 508 may also consider additional information, such as information associated with a consumer requesting a value of a coupon (e.g., the consumer 102 using the payer device 116 at a location of the merchant 104). The financial transaction processing server 112 may utilize consumer information (e.g., stored in the consumer information database 302) as part of the value rule 508. In an exemplary embodiment, the value rule 508 may only use consumer information for the consumer 102 if the consumer 102 has opted-in to the service. Types of consumer information suitable for use in value rules will be apparent to persons having skill in the relevant art and may include demographic information, transaction information, and financial information. For example, a value rule 508 may include that a consumer that has a history of shopping at the merchant 104 may have a higher chance at a higher (e.g., better) coupon value. Alternatively, a value rule 508 may include that a first-time consumer receive the highest coupon value available.

In some instances, the value rule 508 may include that a coupon be directed towards different products (e.g., specific products, departments, brands, etc.), such as based on consumer information. For example, a value rule 508 for a coupon to be used at a department store may include that a consumer with a high tendency to purchase sporting goods may receive a coupon value towards a sporting good purchase, whereas a different consumer with a high tendency to purchase electronics may receive a coupon value towards electronics purchases. It will be apparent to persons having skill in the relevant art that example value rules as discussed herein are provided for illustration purposes only.

In one embodiment, the coupon value rule 502 may further include a discount amount, which may include the value of the corresponding coupon based on the value rule 508. In such an embodiment, the value of the corresponding coupon may be determined prior to distribution of the value and/or the use of the coupon in a financial transaction, and still be unavailable to the consumer 102.

### Graphical User Interface Displaying Electronic Coupons

FIG. 6 illustrates an exemplary graphical user interface displayed on the display 120 of the payer device 116. The display 120 may display a plurality of electronic coupons 604 (e.g., and stored in the electronic coupon database 124). The user of the payer device 116 (e.g., the consumer 102) may select a selected coupon 602 from the plurality of electronic coupons 604. Details of the selected coupon 602 may be displayed in a coupon detail window 606.

The coupon detail window 606 may display details associated with the selected coupon 602 in the electronic coupon database 124. In one embodiment, the coupon detail window 606 may display details received (e.g., from a third party) in response to a request for details for the selected coupon 602. The coupon detail window 606 may include a machine-readable code 608. The machine-readable code 608 may be encoded with at least a coupon identifier (e.g., the coupon identifier 504) corresponding to the selected coupon 602. In one embodiment, the coupon detail window 608 may display the encoded coupon identifier as coupon identifier 610. A merchant (e.g., the merchant 104) may use a reader device to read the machine-readable code 608, or may use an input device to input the coupon identifier 610, to identify the selected coupon 602. In some embodiments, the coupon detail window 606 may further include an immediate purchasing period associated with the selected coupon 602.

The coupon detail window 606 may further include a button 612, such as the button 612 illustrated in FIG. 6 labeled “Unlock Scan.” The button 612 may, when selected by the user of the payer device 116, initiate a process to identify the geographic location of the payer device 116 and request and subsequently obtain the value of the selected coupon 602. For example, the button 612 may engage a reader unit included in the payer device 116 to read a machine-readable code display by the merchant 104, which, when read, will confirm that the payer device 116 is located within a physical location of the merchant 104. In another example, the button 612 may engage a location unit that identifies the geographic location of the payer device 116, such as by using the global positioning system (GPS). The confirmation of the location may subsequently be transmitted, along with the coupon identifier 610, to the financial transaction processing server 112 for determination of the value of the selected coupon 602. When received, the value of the selected coupon 602 may be displayed by the payer device 116 (e.g., in the coupon detail window 606).

### Server Architecture

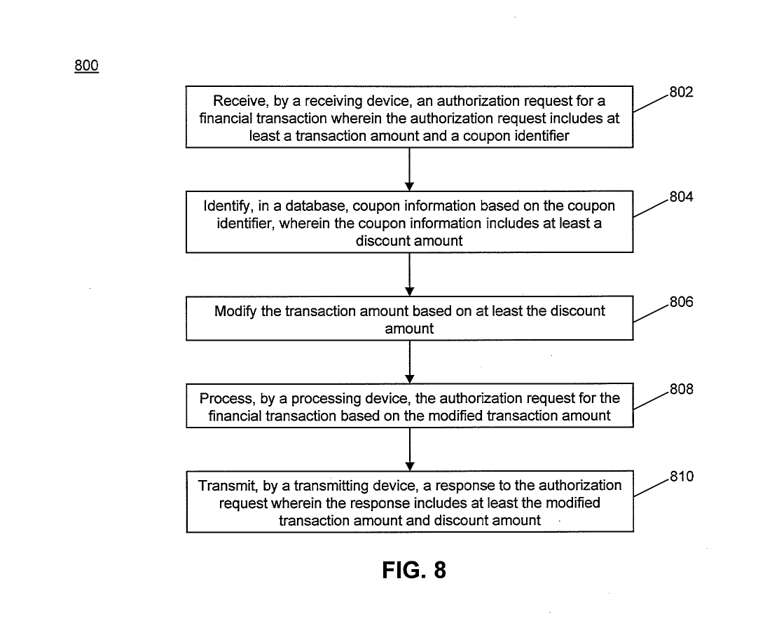

FIG. 7 illustrates a computer system 700 in which embodiments of the present disclosure, or portions thereof, may be implemented as computer-readable code. For example, the financial transaction processing server 112, payer device 116, merchant POS 126, or portions of the acquirer 106 or issuer 108, of FIGS. 1 and 2 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8-11, discussed below.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 122), multi-core message-passing scheme, etc. The computer system 800 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 8-11 as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### First Exemplary Method for Processing a Financial Transaction

FIG. 8 illustrates a method 800 for processing a financial transaction including a variable redemption value coupon.

In step 802, an authorization request for a financial transaction may be received, wherein the authorization request includes at least a transaction amount and a coupon identifier (e.g., the coupon identifier 504). In one embodiment, the coupon identifier may be encoded in a custom field in the authorization request. In a further embodiment, the authorization request may be formatted pursuant to the ISO 8583 standard.

In step 804, coupon information (e.g., the coupon value rule 502) based on the coupon identifier 504 may be identified in a database (e.g., the coupon value rule database 114), wherein the coupon information includes at least a discount amount. In one embodiment, step 804 may further include determining the discount amount based on at least one value rule (e.g., the value rule 508) included in the coupon information. In some embodiments, the discount amount may be a percentage. In other embodiments, the discount amount may be a number.

In step 806, the transaction amount may be modified based on at least the discount amount. In one embodiment, modifying the transaction amount may include subtracting the discount amount from the transaction amount. In step 808, the authorization request for the financial transaction may be modified by a processing device (e.g., the processor 306) based on the modified transaction amount. In one embodiment, modifying the authorization request may include replacing the transaction amount encoded in the authorization request with the modified transaction amount.

In step 810, a response to the authorization request may be transmitted, by a transmitting device (e.g., the transmitting unit 308), wherein the response includes at least the modified transaction amount and discount amount. In one embodiment the response to the authorization request may be formatted pursuant to the ISO 8583 standard.

### Second Exemplary Method for Processing a Financial Transaction

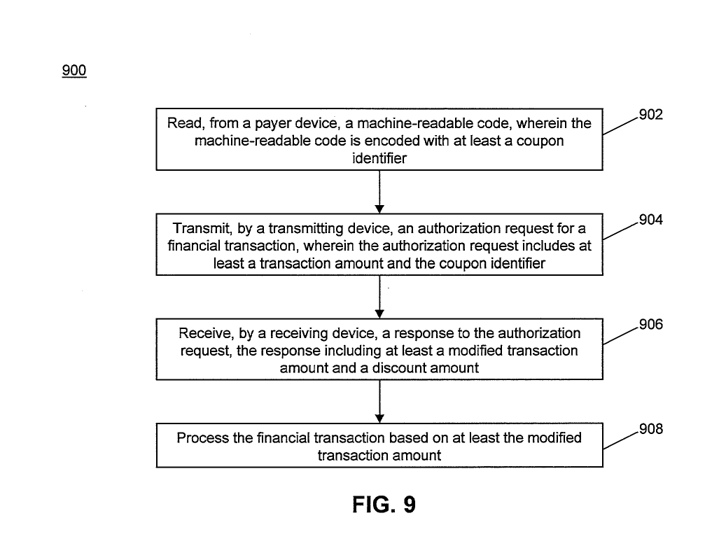

FIG. 9 illustrates a method 900 for processing a financial transaction.

In step 902, a machine-readable code (e.g., the machine-readable code 122) may be read, from a payer device (e.g., the payer device 116), wherein the machine-readable code 122 is encoded with at least a coupon identifier (e.g., the coupon identifier 504). In one embodiment, the payer device 116 may be a mobile communication device. In a further embodiment, the mobile communication device may be a smart phone. In one embodiment, the machine-readable code 122 may be a bar code. In a further embodiment, the bar code may be a QR code. In an exemplary embodiment, the machine-readable code 122 may not be encoded with a discount amount or value.

In step 904, an authorization request for a financial transaction may be transmitted, by a transmitting device (e.g., included in the merchant POS 126), wherein the authorization request includes at least a transaction amount and the coupon identifier 504. In one embodiment, the coupon identifier 504 may be encoded in a custom field of the authorization request. In a further embodiment, the authorization request may be formatted in the ISO 8583 standard.

In step 906, a response to the authorization request may be received, by a receiving device (e.g., included in the merchant POS 126), wherein the response includes at least a modified transaction amount and a discount amount. In one embodiment, the discount amount may be determined based on at least one value rule (e.g., the value rule 508). In some embodiments, the discount amount may be a percentage. In other embodiments, the discount amount may be a number, e.g., a dollar amount of reduction. In still other embodiments, some other consideration, such as free delivery and set-up financing, reduction of certain transaction fees, can be the discount.

In step 908, the financial transaction may be processed based on at least the modified transaction amount. In one embodiment, the method 900 may further include transmitting, for display on the payer device 116, the discount amount to the payer device 116.

### First Exemplary Method for Distributing the Value of an Electronic Coupon

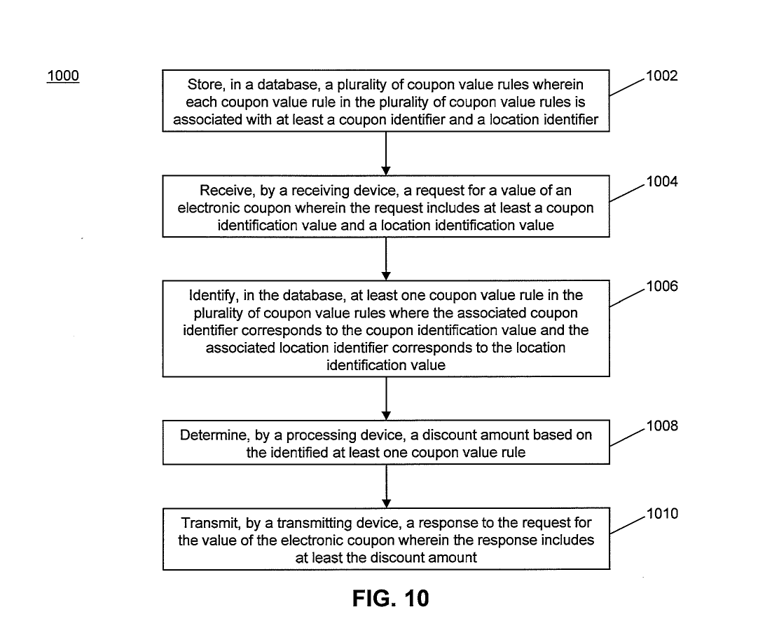

FIG. 10 illustrates an exemplary method 1000 for the distribution of a value of an electronic coupon.

In step 1002, a plurality of coupon value rules (e.g., coupon value rules 502) may be stored in a database (e.g., the coupon value rule database 114), wherein each coupon value rule 502 in the plurality of coupon value rules is associated with at least a coupon identifier (e.g., the coupon identifier 504) and a location identifier (e.g., the location identifier 506).

In step 1004, a request for a value of an electronic coupon may be received, by a receiving device (e.g., the receiving unit 304), wherein the request includes at least a coupon identification value and a location identification value. In one embodiment, the location identification value may be a representation of the geographic location of a device (e.g., the payer device 116) requesting the value of the electronic coupon.

In step 1006, at least one coupon value rule 502 in the plurality of coupon value rules may be identified in the coupon value rule database 114, where the associated coupon identifier 504 corresponds to the coupon identification value and the associated location identifier 506 corresponds to the location identification value. In one embodiment, the at least one coupon value rule 502 may be a time based value rule. In another embodiment, the at least one coupon value rule 502 may be based on a number of redemptions of the electronic coupon corresponding to the associated coupon identifier.

In some embodiments, the request for the value of the electronic coupon may further include information identifying a consumer (e.g., the consumer 102), and identifying the at least one coupon value rule 502 may be further based on a profile associated with the consumer 102. In a further embodiment, the profile associated with the consumer may include at least demographic information associated with the consumer 102. In an alternative further embodiment, the profile may include financial and/or transaction information associated with the consumer 102.

In step 1008, a discount amount may be determined, by a processing device (e.g., the processor 306), based on the identified at least one coupon value rule 502 (e.g., using at least one included value rule 508). In one embodiment the discount amount may be a number. In another embodiment, the discount amount may be a percentage.

In step 1010, a response to the request for the value of the electronic coupon may be transmitted, by a transmitting device (e.g., the transmitting unit 308), wherein the response includes at least the discount amount. In one embodiment, the discount amount may be encoded in a custom field of the response. In a further embodiment, the response may be formatted in the ISO 8583 standard.

### First Exemplary Method for Obtaining a Value of an Electronic Coupon

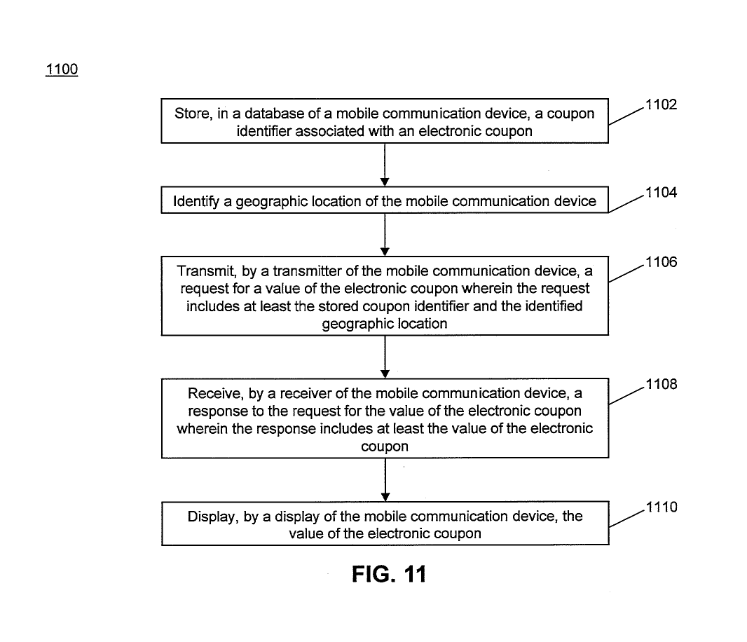

FIG. 11 illustrates a method 1100 for obtaining the value of an electronic coupon.

In step 1102, a coupon identifier (e.g., the coupon identifier 504) associated with an electronic coupon may be stored in a database (e.g., the electronic coupon database 124) of a mobile communication device (e.g., the payer device 116). In step 1104, a geographic location of the mobile communication device may be identified. In one embodiment, identifying the geographic location of the mobile communication device may use at least one of: a communication network, a global positioning system, WiFi, an aural device, scanned code self-reporting, and cellular service reporting. In a further embodiment, the communication network may be a wireless communication network. In an exemplary embodiment, identifying the geographic location of the mobile communication device may include reading, by a reader of the mobile communication device, a machine-readable code, wherein the machine-readable code is encoded with the geographic location. In a further embodiment, the machine-readable code may be a bar code. In an additional further embodiment, the bar code may be a QR code.

In step 1106, a request for a value of the electronic coupon may be transmitted, by a transmitter of the mobile communication device (e.g., the transmitting unit 402), wherein the request includes at least the stored coupon identifier 504 and the identified geographic location (e.g., the location identifier 506). In one embodiment, the request for the value of the electronic coupon may further include information identifying a consumer (e.g., the consumer 102).

In step 1108, a response to the request for the value of the electronic coupon may be received, by a receiver of the mobile communication device (e.g., the receiving unit 404), wherein the response includes at least the value of the electronic coupon. In one embodiment, the value of the electronic coupon may be based on at least one coupon value rule (e.g., the coupon value rule 502). In step 1110, the value of the electronic coupon may be displayed, by a display (e.g., the display 120) of the mobile communication device. In one embodiment, the response to the request for the value of the electronic coupon may include a coupon machine-readable code encoded with the value of the electronic coupon. In a further embodiment, displaying the value of the electronic coupon may include displaying the coupon machine-readable code.

### Second Exemplary Method for Distributing the Value of an Electronic Coupon

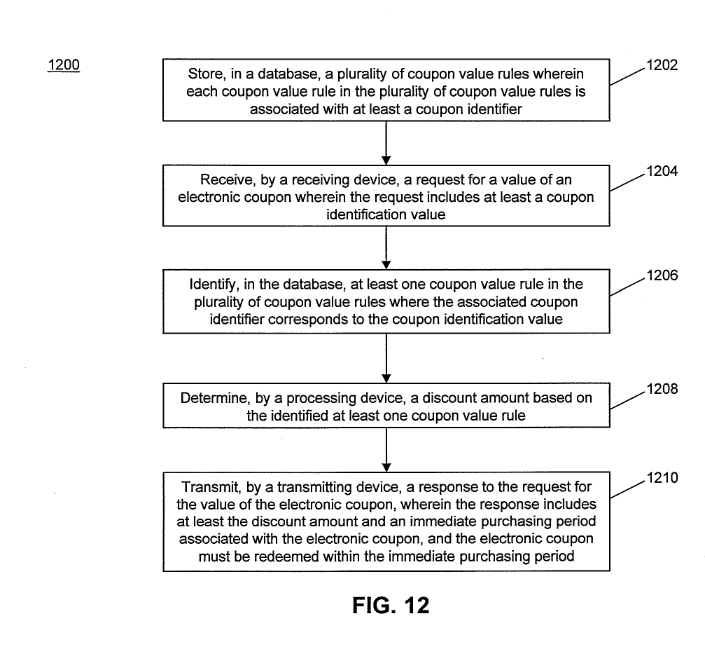

FIG. 12 illustrates an exemplary method 1200 for the distribution of a value of an electronic coupon associated with an immediate purchasing period.

In step 1202, a plurality of coupon value rules (e.g., coupon value rules 502) may be stored in a database (e.g., the coupon value rule database 114), wherein each coupon value rule 502 in the plurality of coupon value rules is associated with at least a coupon identifier (e.g., the coupon identifier 504. In step 1204, a request for a value of an electronic coupon may be received, by a receiving device (e.g., the receiving unit 304), wherein the request includes at least a coupon identification value.

In step 1206, at least one coupon value rule 502 in the plurality of coupon value rules may be identified in the coupon value rule database 114, where the associated coupon identifier 504 corresponds to the coupon identification value. In one embodiment, the at least one coupon value rule 502 may be a time based value rule. In another embodiment, the at least one coupon value rule 502 may be based on a number of redemptions of the electronic coupon corresponding to the associated coupon identifier.

In some embodiments, the request for the value of the electronic coupon may further include information identifying a consumer (e.g., the consumer 102), and identifying the at least one coupon value rule 502 may be further based on a profile associated with the consumer 102. In a further embodiment, the profile associated with the consumer may include at least demographic information associated with the consumer 102. In an alternative further embodiment, the profile may include financial and/or transaction information associated with the consumer 102.

In step 1208, a discount amount may be determined, by a processing device (e.g., the processor 306), based on the identified at least one coupon value rule 502 (e.g., using at least one included value rule 508). In one embodiment the discount amount may be a number. In another embodiment, the discount amount may be a percentage. In step 1210, a response to the request for the value of the electronic coupon may be transmitted, by a transmitting device (e.g., the transmitting unit 308), wherein the response includes at least the discount amount and an immediate purchasing period associated with the electronic coupon, wherein the electronic coupon must be redeemed within the immediate purchasing period. In one embodiment, the discount amount may be encoded in a custom field of the response. In a further embodiment, the response may be formatted in the ISO 8583 standard.

### Second Exemplary Method for Obtaining a Value of an Electronic Coupon

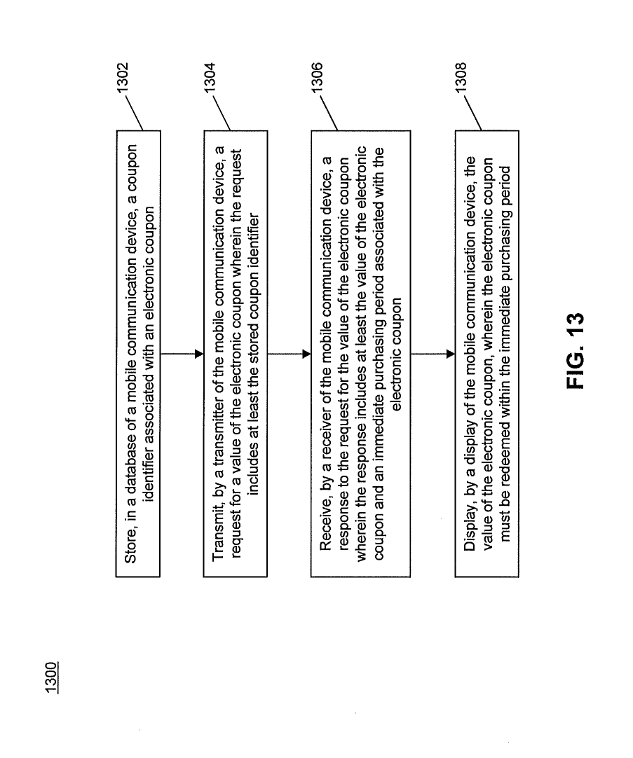

FIG. 13 illustrates a method 1300 for obtaining the value of an electronic coupon associated with an immediate purchasing period.

In step 1302, a coupon identifier (e.g., the coupon identifier 504) associated with an electronic coupon may be stored in a database (e.g., the electronic coupon database 124) of a mobile communication device (e.g., the payer device 116). In step 1304, a request for a value of the electronic coupon may be transmitted, by a transmitter of the mobile communication device (e.g., the transmitting unit 402), wherein the request includes at least the stored coupon identifier 504. In one embodiment, the request for the value of the electronic coupon may further include information identifying a consumer (e.g., the consumer 102).

In step 1306, a response to the request for the value of the electronic coupon may be received, by a receiver of the mobile communication device (e.g., the receiving unit 404), wherein the response includes at least the value of the electronic coupon and an immediate purchasing period associated with the electronic coupon, wherein the electronic coupon must be redeemed within the immediate purchasing period. In one embodiment, the value of the electronic coupon may be based on at least one coupon value rule (e.g., the coupon value rule 502). In step 1110, the value of the electronic coupon may be displayed, by a display (e.g., the display 120) of the mobile communication device. In one embodiment, the response to the request for the value of the electronic coupon may include a coupon machine-readable code encoded with the value of the electronic coupon. In a further embodiment, displaying the value of the electronic coupon may include displaying the coupon machine-readable code. In one embodiment, the coupon machine-readable code may be a bar code. In a further embodiment, the bar code may be a QR code.

Techniques consistent with the present disclosure provide, among other features, systems and methods for applying coupon rules to a financial transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a financial transaction, comprising:
receiving, by a receiving device, an authorization request for a financial transaction wherein the authorization request includes at least a transaction amount and a coupon identifier;
identifying, in a database, coupon information based on the coupon identifier, wherein the coupon information includes at least a discount amount;
modifying the transaction amount based on at least the discount amount;
processing, by a processing device, the authorization request for the financial transaction based on the modified transaction amount; and
transmitting, by a transmitting device, a response to the authorization request, wherein the response includes at least the modified transaction amount and discount amount.

2. The method of claim 1, wherein the coupon identifier is encoded in a custom field in the authorization request.

3. The method of claim 2, wherein the authorization request is formatted in the ISO 8583 standard.

4. The method of claim 1, wherein the discount amount is a percentage.

5. The method of claim 1, wherein the discount amount is a number.

6. A method for processing a financial transaction, comprising:
reading, from a payer device, a machine-readable code, wherein the machine-readable code is encoded with at least a coupon identifier;
transmitting, by a transmitting device, an authorization request for a financial transaction, wherein the authorization request includes at least a transaction amount and the coupon identifier;
receiving, by a receiving device, a response to the authorization request, the response including at least a modified transaction amount and a discount amount; and
processing the financial transaction based on at least the modified transaction amount.

7. The method of claim 6, further comprising:
transmitting, for display on the payer device, the discount amount to the payer device.

8. The method of claim 6, wherein the machine-readable code is a bar code.

9. The method of claim 8, wherein the bar code is a QR code.

10. The method of claim 6, wherein the coupon identifier is encoded in a custom field in the authorization request.

11. The method of claim 10, wherein the authorization request is formatted in the ISO 8583 standard.

12. The method of claim 6, wherein the discount amount is a percentage.

13. The method of claim 6, wherein the discount amount is a number.

14. The method of claim 6, wherein the payer device is a mobile communication device.

15. The method of claim 6, wherein the discount amount is not encoded in the machine-readable code.

16. A method for distributing a value of an electronic coupon, comprising:
storing, in a database, a plurality of coupon value rules wherein each coupon value rule in the plurality of coupon value rules is associated with at least a coupon identifier and a location identifier;
receiving, by a receiving device, a request for a value of an electronic coupon wherein the request includes at least a coupon identification value and a location identification value
identifying, in the database, at least one coupon value rule in the plurality of coupon value rules where the associated coupon identifier corresponds to the coupon identification value and the associated location identifier corresponds to the location identification value;
determining, by a processing device, a discount amount based on the identified at least one coupon value rule; and
transmitting, by a transmitting device, a response to the request for the value of the electronic coupon wherein the response includes at least the discount amount.

17. The method of claim 16, wherein the at least one coupon value rule is a time based value rule.

18. The method of claim 16, wherein the at least one coupon value rule is based on a number of redemptions of an electronic coupon corresponding to the associated coupon identifier.

19. The method of claim 16, wherein the request for the value of the electronic coupon further includes information identifying a consumer, and wherein the at least one coupon value rule is based on a profile associated with the consumer.

20. The method of claim 19, wherein the profile associated with the consumer includes at least demographic information associated with the consumer.

21. A method for obtaining a value of an electronic coupon, comprising:
storing, in a database of a mobile communication device, a coupon identifier associated with an electronic coupon;
identifying a geographic location of the mobile communication device;
transmitting, by a transmitter of the mobile communication device, a request for a value of the electronic coupon wherein the request includes at least the stored coupon identifier and the identified geographic location;
receiving, by a receiver of the mobile communication device, a response to the request for the value of the electronic coupon wherein the response includes at least the value of the electronic coupon; and
displaying, by a display of the mobile communication device, the value of the electronic coupon.

22. The method of claim 21, wherein identifying a geographic location of the mobile communication device includes using at least one of: a communication network, a global positioning system, WiFi, an aural device, scanned code self reporting, and cellular service reporting.

23. The method of claim 22, wherein the communication network is a wireless communication network.

24. The method of claim 21, wherein identifying a geographic location of the mobile communication device includes reading, by a reader of the mobile communication device, a machine-readable code, wherein the machine-readable code is encoded with the geographic location.

25. The method of claim 24, wherein the machine-readable code is a bar code.

26. The method of claim 25, wherein the bar code is a QR code.

27. The method of claim 21, wherein the request for the value of the electronic coupon further includes information identifying a consumer.

28. The method of claim 21, wherein the response to the request for the value of the electronic coupon includes a coupon machine-readable code encoded with the value of the electronic coupon.

29. The method of claim 28, wherein displaying the value of the electronic coupon includes displaying the coupon machine-readable code.

30. A method for distributing a value of an electronic coupon, comprising:
storing, in a database, a plurality of coupon value rules wherein each coupon value rule in the plurality of coupon value rules is associated with at least a coupon identifier;
receiving, by a receiving device, a request for a value of an electronic coupon wherein the request includes at least a coupon identification value
identifying, in the database, at least one coupon value rule in the plurality of coupon value rules where the associated coupon identifier corresponds to the coupon identification value;
determining, by a processing device, a discount amount based on the identified at least one coupon value rule; and
transmitting, by a transmitting device, a response to the request for the value of the electronic coupon, wherein
the response includes at least the discount amount and an immediate purchasing period associated with the electronic coupon, and
the electronic coupon must be redeemed within the immediate purchasing period.

31. The method of claim 30, wherein the at least one coupon value rule is a time based value rule.

32. The method of claim 30, wherein the at least one coupon value rule is based on a number of redemptions of an electronic coupon corresponding to the associated coupon identifier.

33. The method of claim 30, wherein the request for the value of the electronic coupon further includes information identifying a consumer, and wherein the at least one coupon value rule is based on a profile associated with the consumer.

34. The method of claim 33, wherein the profile associated with the consumer includes at least demographic information associated with the consumer.

35. A method for obtaining a value of an electronic coupon, comprising:
storing, in a database of a mobile communication device, a coupon identifier associated with an electronic coupon;
transmitting, by a transmitter of the mobile communication device, a request for a value of the electronic coupon wherein the request includes at least the stored coupon identifier;
receiving, by a receiver of the mobile communication device, a response to the request for the value of the electronic coupon wherein the response includes at least the value of the electronic coupon and an immediate purchasing period associated with the electronic coupon; and
displaying, by a display of the mobile communication device, the value of the electronic coupon, wherein
the electronic coupon must be redeemed within the immediate purchasing period.

36. The method of claim 35, wherein the request for the value of the electronic coupon further includes information identifying a consumer.

37. The method of claim 35, wherein the response to the request for the value of the electronic coupon includes a coupon machine-readable code encoded with the value of the electronic coupon.

38. The method of claim 37, wherein displaying the value of the electronic coupon includes displaying the coupon machine-readable code.

39. The method of claim 37, wherein the coupon machine-readable code is a bar code.

40. The method of claim 39, wherein the bar code is a QR code.

41. A system for processing a financial transaction, comprising:
a receiving device configured to receive an authorization request for a financial transaction wherein the authorization request includes at least a transaction amount and a coupon identifier;
a database configured to store coupon information for a coupon associated with the coupon identifier, wherein the coupon information includes at least a discount amount;
a processor configured to
identify the coupon information for the coupon associated with the coupon identifier,
modify the transaction amount based on the discount amount, and
process the authorization request for the financial transaction based on the modified transaction amount; and
a transmitting device configured to transmit a response to the authorization request, wherein the response includes at least the modified transaction amount and discount amount.

42. The system of claim 41, wherein the coupon identifier is encoded in a custom field in the authorization request.

43. The system of claim 42, wherein the authorization request is formatted in the ISO 8583 standard.

44. The system of claim 41, wherein the discount amount is a percentage.

45. The system of claim 41, wherein the discount amount is a number.

46. A system for processing a financial transaction, comprising:
a reading device configured to read, from a payer device, a machine-readable code, wherein the machine-readable code is encoded with at least a coupon identifier;
a transmitting device configured to transmit an authorization request for a financial transaction, wherein the authorization request includes at least a transaction amount and the coupon identifier;
a receiving device configured to receive a response to the authorization request, the response including at least a modified transaction amount and a discount amount; and
a processor configured to process the financial transaction based on the modified transaction amount.

47. The system of claim 46, further comprising:
transmitting, for display on the payer device, the discount amount to the payer device.

48. The system of claim 46, wherein the machine-readable code is a bar code.

49. The system of claim 48, wherein the bar code is a QR code.

50. The system of claim 46, wherein the coupon identifier is encoded in a custom field in the authorization request.

51. The system of claim 50, wherein the authorization request is formatted in the ISO 8583 standard.

52. The system of claim 46, wherein the discount amount is a percentage.

53. The system of claim 46, wherein the discount amount is a number.

54. The system of claim 46, wherein the payer device is a mobile communication device.

55. The system of claim 46, wherein the discount amount is not encoded in the machine-readable code.

56. A system for distributing a value of an electronic coupon, comprising:
a database configured to store a plurality of coupon value rules wherein each coupon value rule in the plurality of coupon value rules is associated with at least a coupon identifier and a location identifier;
a receiving device configured to receive a request for a value of an electronic coupon wherein the request includes at least a coupon identification value and a location identification value;
a processor configured to
identify, in the database, at least one coupon value rule in the plurality of coupon value rules where the associated coupon identifier corresponds to the coupon identification value and the associated location identifier corresponds to the location identification value, and
determine a discount amount based on the identified at least one coupon value rule; and
a transmitting device configured to transmit a response to the request for the value of the electronic coupon wherein the response includes at least the determined discount amount.

57. The system of claim 56, wherein the at least one coupon value rule is a time based value rule.

58. The system of claim 56, wherein the at least one coupon value rule is based on a number of redemptions of an electronic coupon corresponding to the associated coupon identifier.

59. The system of claim 56, wherein the request for the value of the electronic coupon further includes information identifying a consumer, and wherein the at least one coupon value rule is based on a profile associated with the consumer.

60. The system of claim 59, wherein the profile associated with the consumer includes at least demographic information associated with the consumer.

61. A mobile communication device, comprising:
a database configured to store a coupon identifier associated with an electronic coupon;
a processor configured to identify a geographic location of the mobile communication device;
a transmitter configured to transmit a request for a value of the electronic coupon wherein the request includes at least the stored coupon identifier and the identified geographic location;
a receiver configured to receive a response to the request for the value of the electronic coupon wherein the response includes at least the value of the electronic coupon; and
a display configured to display the value of the electronic coupon.

62. The system of claim 61, wherein identifying a geographic location of the mobile communication device includes using at least one of: a communication network, a global positioning system, WiFi, an aural device, scanned code self reporting, and cellular service reporting.

63. The system of claim 62, wherein the communication network is a wireless communication network.

64. The system of claim 61, wherein identifying a geographic location of the mobile communication device includes reading, by a reader of the mobile communication device, a machine-readable code, wherein the machine-readable code is encoded with the geographic location.

65. The system of claim 64, wherein the machine-readable code is a bar code.

66. The system of claim 65, wherein the bar code is a QR code.

67. The system of claim 61, wherein the request for the value of the electronic coupon further includes information identifying a consumer.

68. The system of claim 61, wherein the response to the request for the value of the electronic coupon includes a coupon machine-readable code encoded with the value of the electronic coupon.

69. The system of claim 68, wherein displaying the value of the electronic coupon includes displaying the coupon machine-readable code.

70. A system for distributing a value of an electronic coupon, comprising:
a database configured to store a plurality of coupon value rules wherein each coupon value rule in the plurality of coupon value rules is associated with at least a coupon identifier;
a receiving device configured to receive a request for a value of an electronic coupon wherein the request includes at least a coupon identification value;
a processor configured to
identify, in the database, at least one coupon value rule in the plurality of coupon value rules where the associated coupon identifier corresponds to the coupon identification value, and
determine a discount amount based on the identified at least one coupon value rule; and
a transmitting device configured to transmit a response to the request for the value of the electronic coupon, wherein
the response includes at least the determined discount amount and an immediate purchasing period associated with the electronic coupon, and
the electronic coupon must be redeemed within the immediate purchasing period.

71. The system of claim 70, wherein the at least one coupon value rule is a time based value rule.

72. The system of claim 70, wherein the at least one coupon value rule is based on a number of redemptions of an electronic coupon corresponding to the associated coupon identifier.

73. The system of claim 70, wherein the request for the value of the electronic coupon further includes information identifying a consumer, and wherein the at least one coupon value rule is based on a profile associated with the consumer.

74. The system of claim 73, wherein the profile associated with the consumer includes at least demographic information associated with the consumer.

75. A mobile communication device, comprising:
a database configured to store a coupon identifier associated with an electronic coupon;
a transmitter configured to transmit a request for a value of the electronic coupon wherein the request includes at least the stored coupon;
a receiver configured to receive a response to the request for the value of the electronic coupon wherein the response includes at least the value of the electronic coupon and an immediate purchasing period associated with the electronic coupon; and
a display configured to display the value of the electronic coupon, wherein
the electronic coupon must be redeemed within the immediate purchasing period.

76. The system of claim 75, wherein the request for the value of the electronic coupon further includes information identifying a consumer.

77. The system of claim 75, wherein the response to the request for the value of the electronic coupon includes a coupon machine-readable code encoded with the value of the electronic coupon.

78. The system of claim 77, wherein displaying the value of the electronic coupon includes displaying the coupon machine-readable code.

79. The system of claim 77, wherein the coupon machine-readable code is a bar code.

80. The system of claim 79, wherein the bar code is a QR code.
